(19) United States
(12) Patent Application Publication
(10) Pub. No.: US 2015/0020189 A1
(43) Pub. Date: Jan. 15, 2015

(54) ELECTRO-MECHANIC USB LOCKING DEVICE

(71) Applicant: High Sec Labs ltd., Yokneam (IL)

(72) Inventor: Aviv SOFFER, Caesarea (IL)

(21) Appl. No.: 13/937,581

(22) Filed: Jul. 9, 2013

(51) Int. Cl. G06F 21/70

(52) U.S. Cl. CPC G06F 21/70
USPC 726/16

(57) ABSTRACT

USB ports present risk of data leak from computers. The invention provides an electromechanical USB port protection device capable of mechanically block unused USB port, thus preventing the connection of any USB device to that port. Removal of the device requires electrically energizing the lock using security code. Security software provides scalable and secure centralized keys management. The device provides clear and continuous user visual indications when device is secure. Device derivative secures USB cable to the computer USB port. Another device derivative filters and secures a connected user peripheral device, for example a USB locking device that only allows a connection of USB mouse or keyboard.

### FIELD OF THE INVENTION

The present invention relates to a device and a method that enhances computer information security through physically blocking unused USB ports with an electromechanical lock. Another embodiment of the current invention locks a USB cable to the computer USB port. Yet another embodiment of the current invention provides a USB port locking device with internal circuitry that qualifies and secures the attached user peripheral device.

### BACKGROUND OF THE INVENTION

Generally, universal serial bus (USB) ports provide a serial bus standard for connecting devices to computers. Most modern computers include at least one, and usually a plurality of USB ports. USB ports are used to connect peripherals such as mice, keyboards, scanners, digital cameras, printers, external storage, etc. Anyone with access to a computer's USB port can plug a portable flash drive or other mass storage device into the port and attempt to download information from the computer. Unauthorized, downloading information from the computer is a security problem.

US Patent application 2008/0041125 USB PORT LOCKING AND BLOCKING DEVICE, to Carl Poppe, discloses a mechanical lock for USB ports.

PCT application WO2013042108) SECURITY PLUG FOR PREVENTING ACCESS TO A USB SOCKET AND SECURED USB DEVICEA, to Zeuveni Zadok, discloses a security plug for preventing access to a USB socket adapted to complete an electrical circuit when inserted into the USB socket such that its removal from the USB socket breaks the circuit and is detected by a host computer.

A mechanical lock for USB port is available from Kensington (www.kensington.com)

Another mechanical lock for USB port is available from Lidy (LINDY USA, 14327 Bledsoe Rd. Athens, Ala. 35613 (http://www.lindy-usa.com/)

Security software (SW) that locks and manages the USB ports are available. However, as with any software based security measure, this software may be bypassed, for example if the computer is infected, or if the abuser has obtained administrator permissions.

For example: USB flash dive control software may be downloaded from http://www.softpedia.com/get/System/System-Miscellaneous/USB-Port-Blocker.shtml USB blocker software may be obtained from iSM—Institut für System-Management. Oldendorfer Str. 12, 18147 Rostock, Germany (http://www.usb-blocker.com/)

### SUMMARY OF THE EMBODIMENTS

In view of the security risks associated with USB devices connected to computers, and in view of the shortcoming of prior art USB protection methods and devices, there is a need for a USB port protection device that at least will provide few of the following:
1. Mechanically block unused USB ports thus preventing the connection of any USB device to that port;
2. Will enable safe device removal using a scalable and secure centralized security permissions enforcement management; and
3. Provide clear and optionally continuous visual indications when the device and/or the computer is secure.

To further leverage such security device, it is desirable that the following derivative devices will be provided:
Device derivative that secures USB cable to the computer USB port;
Device derivative that filters and secure the connected user peripheral device. For example a USB locking device that only allows a connection of USB mouse or keyboard.

It is an object of a current invention to provide an electromechanically activated lock for a computer port comprising: a plug capable of mating with a port of a host computer; an electromechanical lock, capable of locking the said plug to said port, wherein said electromechanical lock is capable of being activated by security software.

It is another object of a current invention to provide an Electronic USB Security Device comprising: USB security plug (13), capable of interfacing the Electronic USB Security Device with a host device (30) USB jack (31); at least one locking tooth (8), shaped to lock inside standard USB jack (33) shielding tab holes (34); and a solenoid (24), capable of enabling and disabling the device locking through mechanical linkage with said at least one locking tooth (8).

In some embodiments the Electronic USB Security device is further comprising of an Authentication and security function, capable of enabling positive authentication of the device by software installed at said host device.

In some embodiments the solenoid is controlled by said Authentication and security function based on commands received from said coupled host device.

In some embodiments the solenoid is configured to enable locking when de-energized and unlocking when energized.

In some embodiments the mechanical linkage is a metal lever that pulled by said solenoid when said solenoid is energized, and mechanically restricts the movement of the said at least one locking tooth when said solenoid is not energized.

In some embodiments the device further comprising a visual indicator to provide visual indication of device lock and unlock states to the user, and wherein said visual indicator is selectable from the list consisting of: Light Emitting Diode (LED), Lamp, electromagnetic colored flag and Liquid Crystal Display (LCD).

In some embodiments the device further comprising a push-button, coupled to at least one locking tooth, to enable safe removal of the device by user mechanical input force pushing said push-button.

In some embodiments the device further comprising a Leaf spring, coupled to at least one tooth, to force said at least one locking tooth into the mating USB jack shielding tab holes.

In some embodiments the device further comprising a sensor, capable of providing electrical feedback about the device lock and unlock states.

In some embodiments the device further comprises at least one removable ring, selectable from the list consisting of: filler removable rings to enable user device adjustment to various hosts USB jack wall thicknesses; and removable oversized rings to enable mechanical blocking of nearby connector.

In some embodiments the device further comprising at least one Tamper Evident Labels (TEL) to enable authenticity validation and device physical tampering visual indications.

In some embodiments the device further comprises a Security Controller Function that drives the said solenoid and coupled to a remote controller receiver function, wherein said remote-control receiver function is capable of receiving user commands from a remote control device through communication channels selectable from the list consisting of: radio frequency antenna; loop antenna; and electrical contacts.

In some embodiments the device further comprising at least one mechanically fixed cable, wherein said at least one cable is coupled to the device USB plug at one end.

In some embodiments the Solenoid is controlled through the coupled cable from a connected USB device.

In some embodiments the device further comprises: a USB jack, to connect user USB device; a USB Host interface Emulator function, coupled to the said USB jack on one side, and coupled to a unidirectional serial data output on the other side; a USB Device Emulator function, coupled to the said USB plug on one side, and coupled to a unidirectional serial data input on the other side; and a Unidirectional data flow enforcing device, coupled to said USB Host Emulator function unidirectional serial data output, and coupled to the said USB Device Emulator function unidirectional serial data input, wherein the device is programmed to enumerate pre-defined user USB devices only.

In some embodiments the solenoid is configured to enable locking when de-energized and unlocking when energized.

In some embodiments the mechanical linkage is a metal lever that is capable of being pulled by said solenoid, and when not pulled mechanically restricts the movement of the said at least one tooth.

In some embodiments the device further comprises a visual indicator or providing visual indication of device lock and unlocks states to the user, wherein visual indicator are selectable from the list of: Light Emitting Diode (LED), Lamp, electromagnetic colored flag and Liquid Crystal Display (LCD).

In some embodiments the device further comprising a push-button coupled to said at least one tooth to enable safe removal of the device by user mechanical input force pushing said push-button.

In some embodiments the device further comprising a Leaf spring coupled to at least one tooth to force said at least one tooth into the mating USB jack shielding tab holes.

In some embodiments the device further comprising a sensor capable of providing an electrical feedback about the device lock and unlock states.

In some embodiments the device further comprises at least one removable ring selectable from the list consisting of: filler removable rings to enable user device adjustment to various host USB jack wall thicknesses; and removable oversized rings to enable mechanical blocking of nearby connector.

In some embodiments the device further comprises at least one Tamper Evident Labels (TEL) to enable authenticity validation and device physical tampering visual indications.

In some embodiments the solenoid is controlled by the Host Emulator function to enable device unlocking using a connected USB device.

In some embodiments the device further comprises: a USB jack, to connect user USB device; a USB Physical layer function, coupled to the said USB jack on one side, and coupled to a Core function on the other side; a USB Physical layer function, coupled to the said USB plug on one side, and coupled to said Core on the other side; and a Core function, said Core function is capable of performing functions selectable from the list consisting of: enabling enumeration of only predefined user devices based pre-programmed profile; passing only specific USB packets based on predefined profile; blocking specific USB packets based on predefined profile; acting as a unidirectional device enabling data flow in only one specific direction; and emulating USB host and USB device for specific devices.

It is another object of a current invention to provide a method removing an electromechanical USB lock device from a USB port of a host computer by an authorized user comprising: verifying that the host computer is powered, wherein a security software in said host computer is automatically executed on power-up of said host and periodically communicating with the electromechanical USB lock device, wherein said electromechanical USB lock device is locked in the USB port of a host computer; entering a code associated with said electromechanical USB lock device into a remote device; communicating and authenticating a lock-release command from said remote device to said USB lock device; in response to said lock-release command, unlocking said electromechanical USB lock device from said USB port; and removing said electromechanical USB lock device from said USB port.

In some embodiments the method removing an electromechanical USB lock device from a USB port of a host computer further comprises logging the removal event in the security software with data entries selected from a group consisting of: authorized user name, removed USB lock device details, time and date.

In some embodiments the method removing an electromechanical USB lock device from a USB port of a host computer further comprises enabling the use of said USB port through said security software as defined by the authorized user permissions level and applicable network management group policies.

In some embodiments the security software in the periodically communicating with the device to provide continuous security through keep alive and re-authentication.

In some embodiments the Remote device authenticates the USB lock and communicates (via server) to the host that it is OK to remove.

In some embodiments the USB lock device energizing the solenoid and provides proper user indication through Red LED illumination.

In some embodiments, once the USB lock device is removed—it fails to communicate with the security SW and as result the security SW changing its state to “removed”.

In some embodiments the removal event is logged in the security SW with data entries such as authorized user name, removed USB lock device details, time and date.

It is another object of a current invention to provide a method for installing an electromechanical USB lock device by an authorized user, and continuous monitoring of the USB lock device, the method comprises: accessing a Security software, and entering an applicable USB lock device identification and a host computer identification; entering the installation mode in said Security software[verifying that said host computer is powered; inserting the USB lock device into the appropriate host USB jack; and authenticating said the USB lock device and recording the results.

In some embodiments the user verifies that the selected host is powered on or turns on the selected host.

In some embodiments the authorized user slowly inserting the USB lock device into the appropriate host USB jack, and once USB lock device plug contacts are in contact with the host computer USB jack contacts, it powers up and waiting for commands from Security SW.

In some embodiments the Security SW sends lock-disable command to the target USB lock device, and once lock disable command received by the USB security device, a solenoid is energized and a LED is illuminated in red color.

In some embodiments the authorized user can then push a push-button and fully insert the device to the host USB jack.

In some embodiments the, once the solenoid is de-energized, the USB lock device sensing the state through switch or sensor report back to the Security SW that the device is locked and the LED is illuminating in green color.

In some embodiments the Security SW authenticates the USB lock device and records the results and the installation event is logged in the security SW with data entries such as authorized user name, inserted USB lock device details, time and date.

In some embodiments the Security SW periodically re-authenticates each one of the USB Lock devices to maintain the system security. Each successful/unsuccessful authentication is reported to the log database

It should be noted that embodiments of the current invention enable safe device removal using a scalable and secure centralized security permissions enforcement management. Mechanical keys known in the art presents severe management challenge, specifically at large organizations. If all (or a plurality of) locks has identical keys across the organization, then there may be a security threat if one key finds its way to the attacker's hand. On the other hand, if each of the keys is different, then it is very difficult for large organization to manage and match these keys to their corresponding lock. The use of electronic keys with electromechanical lock provides flexibility and security even for large and growing organizations. For example, it is possible to assign different levels of authorities (equivalent to individual and master keys) with multiple levels.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Unless marked as background or art, any information disclosed herein may be viewed as being part of the current invention or its embodiments.

### BRIEF DESCRIPTION OF THE OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 Schematically illustrates a prior-art USB security plug for preventing access to the USB port based on PCT application WO 2013/042108 A1.

FIG. 2 Schematically illustrates another prior-art device a mechanical USB locking plug described in US Patent application US 2008/0041125 A1.

FIG. 3 Schematically illustrates a high-level block-diagram of an exemplary method and embodiment of the present invention of a USB security plug having an electrical solenoid lock wherein the electrical lock is driven by a security controller function that is coupled to the USB interface, seen here before being plugged into the computer USB jack.

FIG. 4 Schematically illustrates a high-level block-diagram of the exemplary method and embodiment of FIG. 3 as it first touches the computer USB jack's contacts.

FIG. 5 Schematically illustrates a high-level block-diagram of an exemplary method and embodiment of FIGS. 3 and 4 when it is fully plugged in and locked into the computer USB jack.

FIG. 6 Schematically illustrates a high-level block-diagram of an exemplary method and embodiment of the present invention illustrated in FIGS. 3 to 5 above, configured to interface with a computer USB jack having a thick panel wall.

FIG. 7 Schematically illustrates a high-level block-diagram of an exemplary method and embodiment of the present invention illustrated in FIGS. 3 to 6 above, having an oversize removable ring blocking nearby USB jack.

FIG. 8 Schematically illustrates a high-level block-diagram of another exemplary method and embodiment of the present invention of a USB security plug having an electrical solenoid lock driven by a security controller that is coupled to a remote-control receiver.

FIG. 9 Schematically illustrates a high-level block-diagram of another exemplary method and embodiment of the present invention of a keyboard or mouse security device, having unidirectional data flow enforcement, wherein the electrical lock is driven by a security controller coupled to a remote-control receiver.

FIG. 10 Schematically illustrates a high-level block-diagram of another exemplary method and embodiment of the present invention of a USB filter security device.

FIG. 11 Schematically illustrates a high-level block-diagram of another exemplary method and embodiment of the present invention of a keyboard or mouse security device having unidirectional data flow enforcement, similar to the device in FIG. 9 above, wherein, the electrical lock is driven by the host emulator function.

FIG. 12 Schematically illustrates a high-level block-diagram of another exemplary method and embodiment of the present invention of a cable locking device having an electrical lock that is driven by a security controller coupled to a wired or wireless remote-control receiver.

FIG. 13 Schematically illustrates a high-level block-diagram of another exemplary method and embodiment of the present invention of a cable locking device having an electrical lock that is driven by a connected host.

FIG. 14 Schematically illustrates a bottom side view mechanical diagram of an exemplary embodiment of the present invention of a keyboard or mouse security device having a unidirectional data flow enforcing, similar to the device seen in FIG. 9.

FIG. 15 Schematically illustrates a top side view mechanical diagram of an exemplary embodiment of the present invention of a keyboard or mouse security device seen in FIG. 9.

FIG. 16 Schematically illustrates a flowchart of USB Lock device installation by an authorized user and continuous monitoring.

FIG. 17 Schematically illustrates a flowchart of USB Lock device removal by an authorized user.

### DETAILED DESCRIPTION OF THE DRAWINGS

Before explaining at least one embodiment of the invention in detail, it is to be understood that the invention is not necessarily limited in its application to the details set forth in the following description or exemplified by the examples. The invention is capable of other embodiments or of being practiced or carried out in various ways.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements may have been omitted from some of the drawing.

To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, or the like) or multiple pieces of hardware. Similarly, the programs may be stand alone programs, may be incorporated as subroutines in an operating system, may be functions in an installed software package, and the like.

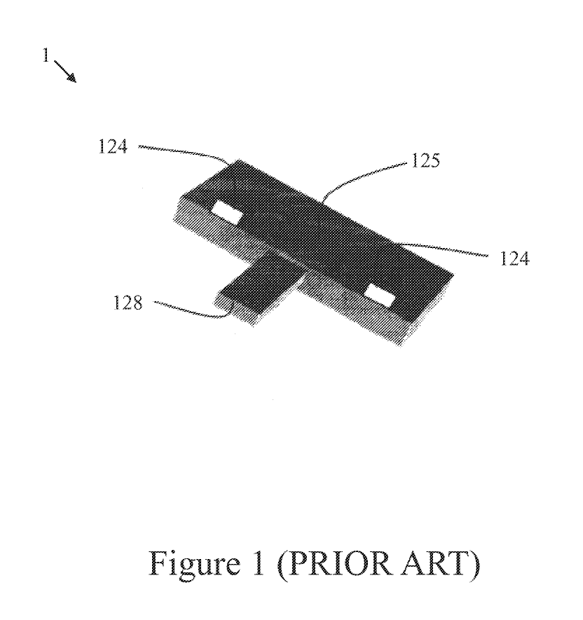

FIG. 1 illustrates a prior-art USB security plug for preventing access to the USB port based on PCT application WO 2013/042108 A1. This prior-art security plug device 1 is used to prevent access to USB port.

The security plug 13 has a planar body portion dimensioned for insertion into the frame of the USB jack (not shown in this figure). The body portion may also be dimensioned such that an end surface thereof is flush with an outer edge of the USB jack frame when the plug is fully inserted therein. At least one prong 124 is supported by a major surface 125 of the body portion for engaging a corresponding aperture in the USB jack frame whereby an edge of the aperture engages the prong 124 and impedes removal of the plug from the socket. A frangible tab 128 fixed to the end surface of the plug and adapted for easy removal therefrom after insertion of the plug into the USB jack. In one embodiment, the frangible tab 128 is adapted to be fractured from the body portion upon attempting to remove the plug from the socket leaving a facture mark. This both prevents removal while also providing an immediate visual indication that the plug has been tampered with.

Also described in this patent application are security functions that enable software detection of the plug presence through software running on the host computer. Between the VBUS and Ground connections (pins 1 and 4 of the USB plug) there is connected a resistor R (not shown in this figure) of sufficiently high value e.g. 100 k Ohm to impose little current drain. Software in the host computer monitors the current flowing between VBUS and Ground so as to detect whether the security plug is connected or removed as a function of current flow. Specifically, any status in the connection or disconnection of the security plug while the computer is operating can be detected in this manner. In order to provide an additional layer of security that prevents tampering while the computer is switched off, a memory device storing a unique ID may be connected across the data pins 2 and 3 so as to allow the host computer to identify the device. The host computer monitors the USB ports and detects when a device is removed or inserted and uses the ID to establish the identity of the device. The user is then prompted to enter an authorization code that is matched to a database of authorized users stored in the computer in order to determine whether the user is authorized to remove or insert the identified device and take precautionary or evasive action if necessary.

While the apparatus described above provides a basic solution for the problem, it is suffering from some severe security vulnerabilities:
1. It does not prevent potential attacker attempting to remove the plug from its jack through brute force. The prior-art apparatus described lack a positive locking mechanism.
2. The prior-art apparatus described is for one-time use. Once inserted into the jack—it is difficult to remove it from the jack without damaging both the device and the jack. Most users would prefer a solution that preserves the function of the USB ports in case that it may be required in the future. For example an administrator may want to use the plugged USB port to reboot or fix that computer.
3. The prior-art apparatus described is not secured when the host computer is powered off. Attacker may override authentication security features by powering of the target computer.

The above security vulnerabilities may prevent the use of such device in organizations having strict security policy.

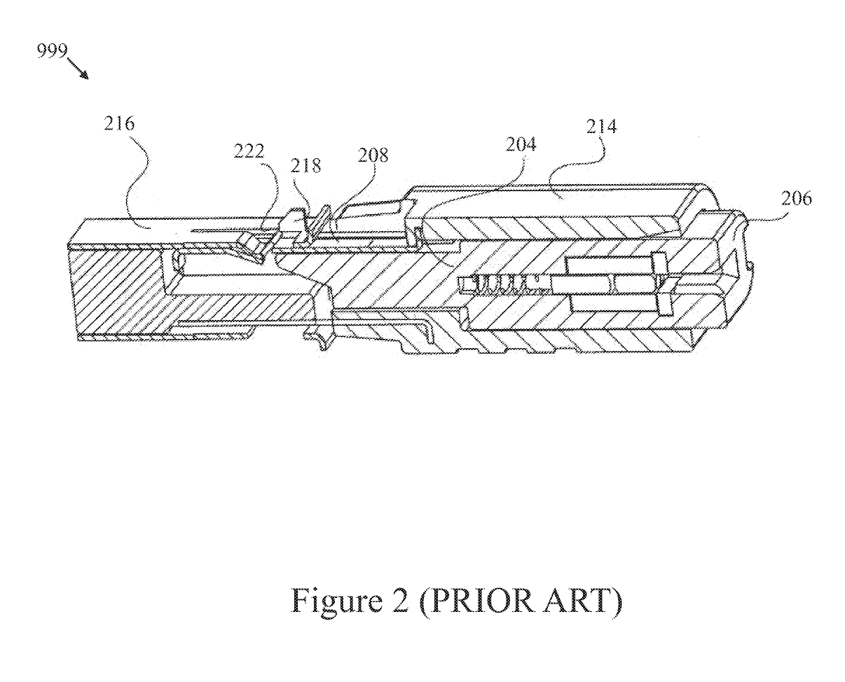

FIG. 2 illustrates a cross-sectional view of another prior-art mechanical USB locking plug device described in US Patent application US 2008/0041125 A1.

A lock 999 with a housing 214 mounted onto a retaining sheath, which is insertable to a USB port (not shown in this figure). Locking member 208 is pivotally connected to the rear end of retaining sheath. Locking member 208 is provided with two protrusions 218, which correspond to standard openings 222 in a USB port 216. Locking member 208 has a bent, preformed shape, such that in the absence of external forces it runs diagonally; its front end is farther inward than its back end. Lock 999 further includes lock button 206 which protrudes from the rear end of housing 214. Lock button 206 is depressible by a user to lock the lock 999. Lock button 206 is connected to linear cam 204, which pivots locking member 208 by cooperating with the ramped camming surface of locking member 208.

While this prior art device solves the physical security problem is suffers from several disadvantages:
1. There is no way for the connected computer to monitor the security of its ports. This apparatus cannot be monitored through software.
2. The use of mechanical keys is not secure. Attacker may gain access to the matching key or even similar key and use it to remove this device. Mechanical locks may be picked relatively easily.
3. Keys management—If all (or a plurality of) locks are identical across the organization then there may be a security threat if one key finds its way to the attacker's hand. On the other hand, if each of the keys is different, then it is very difficult for large organization to manage and match these keys to their corresponding lock.

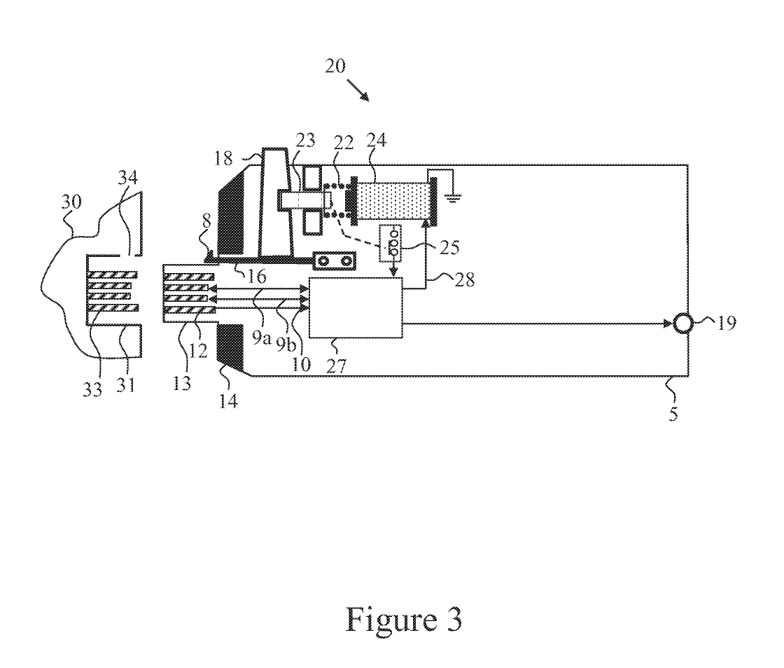

FIG. 3 schematically illustrates a high-level functional diagram of an exemplary method and embodiment of the present invention of a USB security plug having an electromechanical solenoid lock 20. In this figure the USB security plug 20 is not plugged into the computer USB jack yet.

In this embodiment 20 the USB security USB security plug 20 comprises a security plug 13 which is designed to fit standard USB jack 31 of host device 30 such as the one illustrated to at the left side. USB jack 33 may be any open and unused USB port in host PC, laptop, docking station, appliance, server etc. USB security plug 13 comprises electrical contacts 12 which are arranged to touch and make electrical contact with contacts 33 of USB jack 31.

It should be noted that the term “host”, “host device” or “host computer” may be any electronic or computing device having a USB female USB jack.

Authentication and security function 27 is connected to the USB plug contacts 12 through lines 9a and 9b to enable software loaded on host computer 30 to positively authenticate the USB security plug 20.

In this document the term “security function” or other references to “function” or “functions” refer to hardware capable of performing the logical function. The hardware may comprise one or a plurality of electronic circuitries. The hardware may be based on an ASIC (Application Specific Integrated Circuit), a processor accompanied with the necessary memory, a programmable device such as FPGA (Field Programmable Gate Array), or other device or devices capable of performing the desired function. The block diagrams seen here may refer to the function (rather then the hardware sub-units) since modern logical hardware are capable of performing several functions. Thus, a plurality of logical functions may be performed by the same hardware. Alternatively, each logical function may be performed by a dedicated hardware, for example a single chip, or several chips. A man skilled in the art of electronics may find several ways to realize and implement the “function” or “functions”. All such implementations are within the scope of this invention.

Power required for the Authentication and security function 27, and other components in the USB security plug 20 is received from host computer USB contacts 33 via plug contacts 12 and line 10. Power is preferably 5 VDC as defined in USB standard. However, DC to DC power supply or power regulator may be used for modifying the USB standard voltage to voltages, or voltages required for the operation of the USB security 20. Authentication and security function 27 also comprising of switching function that powers the electromechanical solenoid 24 via solenoid activation line 28 based on commands received from host computer 30.

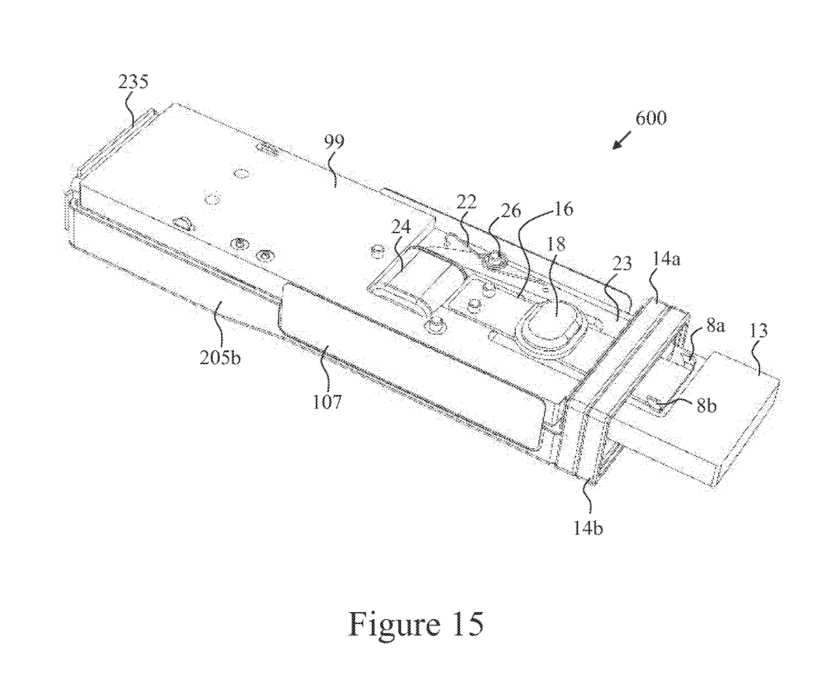

Electromechanical solenoid 24 is coupled to a pin or lever 23 that is loaded to the forward position when solenoid 24 is de-energized by spring 22. Spring 22 may be torsion spring, leaf spring or any other type of elastic component. Metal pin or lever 23 is inserted inside release push-button 18 to prevent user activation of the release action when the electromechanical solenoid 24 is not energized. Pin or lever 23 is preferably made of magnetic metal such that it is influenced by solenoid 24, optionally; the part of pin or lever 23 close to the solenoid 24 is made of magnetic metal such that it is influenced by solenoid 24. Optionally the part of pin or lever 23 close to the solenoid 24 comprises a permanent magnet such that it is influenced by solenoid 24. Optionally pin or lever 23 is constructed as a balanced lever (see FIG. 15) such that it is not influenced by linear acceleration, such that lock cannot be opened by a sharp jerk. Optionally the roles of pin or lever 23 and solenoid 24 are reversed such that solenoid 24 is the moving part.

Push-button 18 is mounted on a flexible leaf spring 16 having one or more locking teeth 8 that are designed to engage with shielding tab holes 34 inside standard USB jack 33, locking the security plug 13 to the USB jack 33. Leaf spring 16 is designed to provide pressure on locking teeth 8 to secure the USB security plug having an electromechanical solenoid lock 20 inside host computer USB jack 31 and to prevent its advertent, malicious, or inadvertent removal.

Optional switch or sensor 25 provides feedback to the Authentication and security function 27 about the current position of the Metal pin or lever 23. Alternatively, sensor 25 is configured to detect the position of push-button 18 or Leaf spring 16.

Optional visual indicator 19, for example an LED derived by Authentication and security function 27 provides user indication when the device is properly locked, for example through green light. Bi-color LED may be used to provide other state indications such as unlocked state (red color for example).

Enclosure 5 is designed to withstand mechanical tampering and therefore it is preferably made from material such as strong plastic or metal alloy. Inclusion of ferromagnetic metal, (for example mu-metal, http://en.wikipedia.org/wiki/Mu-metal) in the enclosure 5 may be used to prevent abusing the USB security plug 20 by attempting to influence lever 23 wing an external magnetic field, for example by placing a magnet near it.

Optionally, one or more Filler Removable rings 14 are designed to fill the gap between the security plug enclosure 5 and the mating USB jack 31 when the USB security plug 20 is fully engaged with the USB jack. These Filler Removable rings 14 may be removed by the user to adjust the device for various thick host computer panels (as will be further explained below).

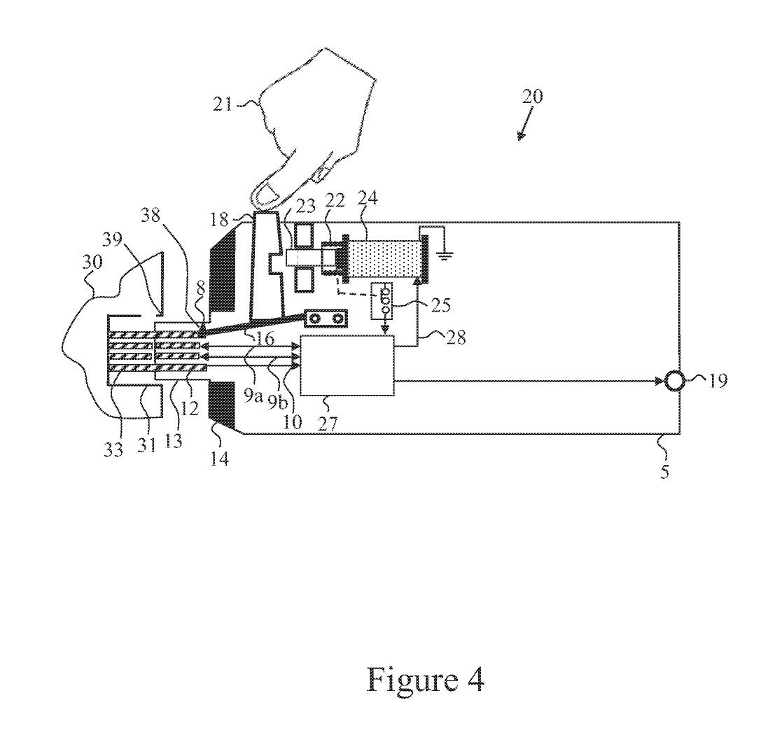

FIG. 4 illustrates a high-level functional diagram of the same USB security plug 20 of the current invention illustrated in FIG. 3 above wherein in this figure the USB security plug 20 is being inserted into the host USB jack 31 while the user 21 presses push-button 18.

During initial insertion of the USB security plug 20, its USB plug contacts 12 touches host USB connector 31 mating contacts 33. Once the coupled Authentication and security function 27 is powered and recognizes initial insertion state it energizes the electromechanical solenoid 24 via solenoid activation 28. Solenoid 24 pulls the metal pin or lever 23 that in turn moves out of the notch in push-button 18 to enables user finger 21 pressing push-button 18 to lower Leaf spring 16 and locking teeth 8 to enable full insertion of security plug 13 of USB security plug 20 into USB lack 31.

Alternatively, user 21 may push the enclosure 5, thus forcing locking teeth 8, Leaf spring 16 to bend downwards as the slopping face 38 of locking teeth 8 meet the edge 39 of USB jack 31.

Optionally, during the USB security plug insertion, when electromechanical solenoid 24 is energized, Authentication and security function 27 turns off LED indicator 19 or changes its color to indicate that the device is not secured.

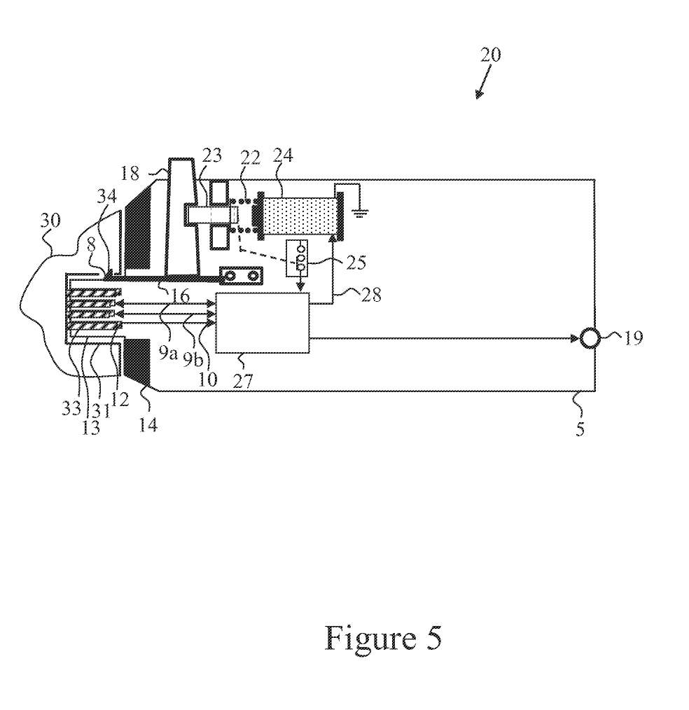

Next FIG. 5 illustrating the same device 20 in its fully inserted state.

FIG. 5 illustrates a high-level functional diagram of the USB security plug embodiment of the current invention illustrated in FIGS. 3 and 4 above wherein in this figure the same USB security plug 20 is fully inserted and secured into the host USB jack 31.

Once the USB security plug 13 of USB security plug 20 is fully inserted into the host USB jack 31, locking teeth 8 penetrates the USB jack shielding tab holes 34 and therefore mechanically secure the USB security plug 20 into position inside host USB jack 31. Locking teeth 8 are sized to fit into USB jack shielding tab holes 34, enabling leaf spring 16 to return to its normal position and push the push-button 18 upwards. When Authentication and security function 27 de-energizes the solenoid 24, metal pin or lever 23 can return into the locked position inside push-button 18 and signal its locked position to Authentication and security function 27 through switch or sensor 25.

Once the USB security plug device 20 reached its locked position as indicated by switch or sensor 25, Authentication and security function 27 turns on LED indicator 19 to indicate that the device is secured.

Once the USB security plug 20 is locked in place, the only possible way to remove it from USB jack 31 is through the following process:
a. The user uses a local or remote security program communicating with the host USB port associated with USB jack 31, to enter a secret key or another authentication protocol as defined in that program.
b. Command is sent to the proper host 30 USB port, associated with USB jack 31, to release the lock. Command is preferably encrypted to improve security.
c. Once the command is received and preferably authenticated by the Authentication and security function 27, the Authentication and security function 27 energizes the solenoid 24 and provides user indication through LED indicator 19.
d. The user then can press the push-button 18 to bend the leaf spring 16 and release the locking teeth 8 from the host USB jack 31 shielding tab holes 34.
e. The user now may pull the USB security plug 20 out of the USB jack 31 of host 30.
f. Local or remote security program may thus detect and record the removal of USB security plug 20 as the security program is not able of communicating with the Authentication and security function 27.

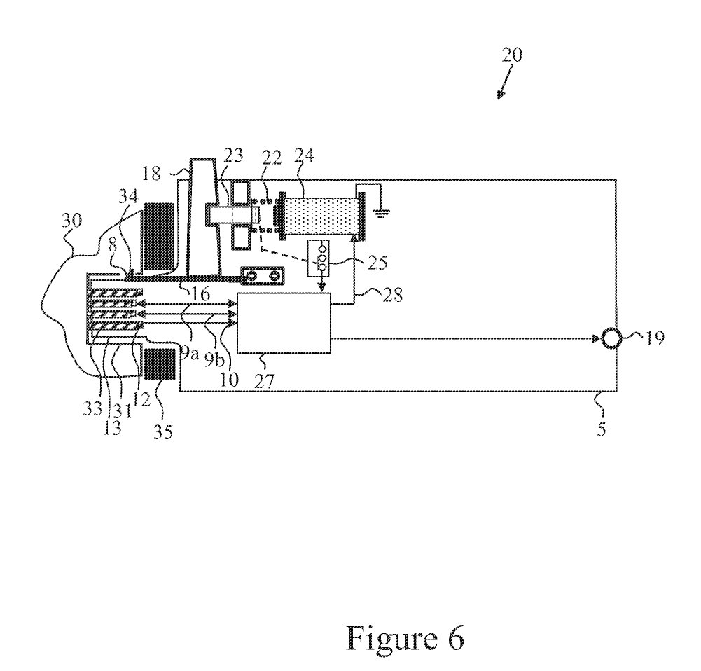

FIG. 6 illustrates a high-level functional diagram of the same USB security plug embodiment of the current invention illustrated in FIGS. 3 to 5 above wherein in this figure the USB security plug 20 is having its filler removable ring 14 (see FIGS. 3-5 above) removed by the user.

Such removal may be needed to enable proper insertion of the USB security plug 20 into the USB jack 31 of host device 30 even when the wall 35 in front of the jack is thick. A thick wall 35 may prevent the proper insertion of the USB security plug 20 and therefore the device is preferably equipped with one or more filler removable rings 14 that enable the user to adjust the device for host device 30 wall thicknesses.

It should be noted that without such filler removable rings 14, a gap between the USB security plug device 20 and the host device 30 USB jack 31 may be formed when wall 35 is thin or missing. Such gap is potential security vulnerability as an attacker may insert a thin tool or metal plate inside that gap and bend the locking teeth 8 and leaf spring 16 downwards to release the USB security plug 20.

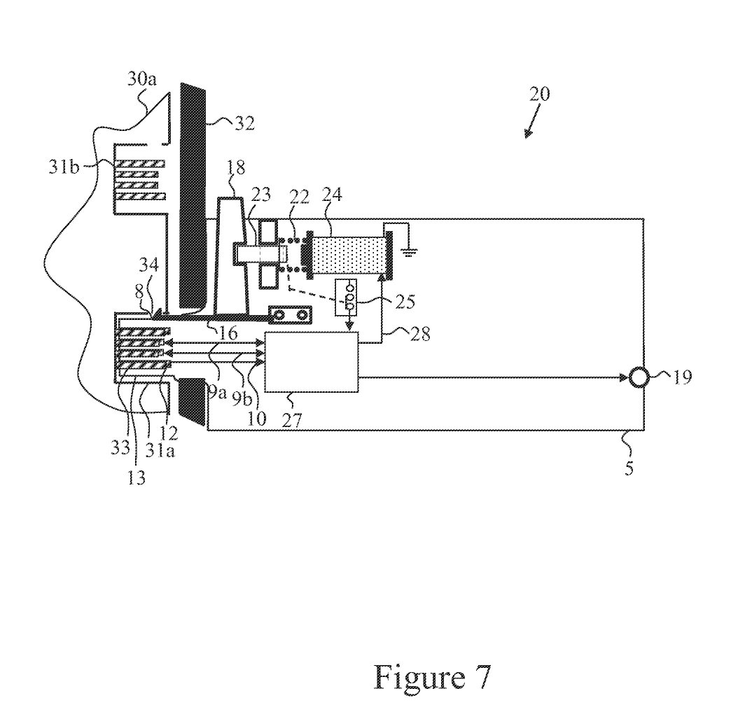

FIG. 7 illustrates a high-level functional diagram of the same USB security plug embodiment of the current invention illustrated in FIGS. 3 to 6 above wherein in this figure the device 20 is having its standard size filler removable ring 14 (see FIGS. 3-5 above) removed by the user and replaced by an oversized removable ring 32.

Such oversized removable ring 32 may be used to enable mechanical blocking of additional nearby USB or other jacks. For example in this FIG. 7 the host device 30a is having USB jack 31a blocked by the USB security plug 20 while nearby USB jack 31b is covered by the oversized removable ring 32.

It should be noted that oversized removable rings 32 may be designed with different shape and installation orientations to enable blocking of connectors located at different positions around the device 20.

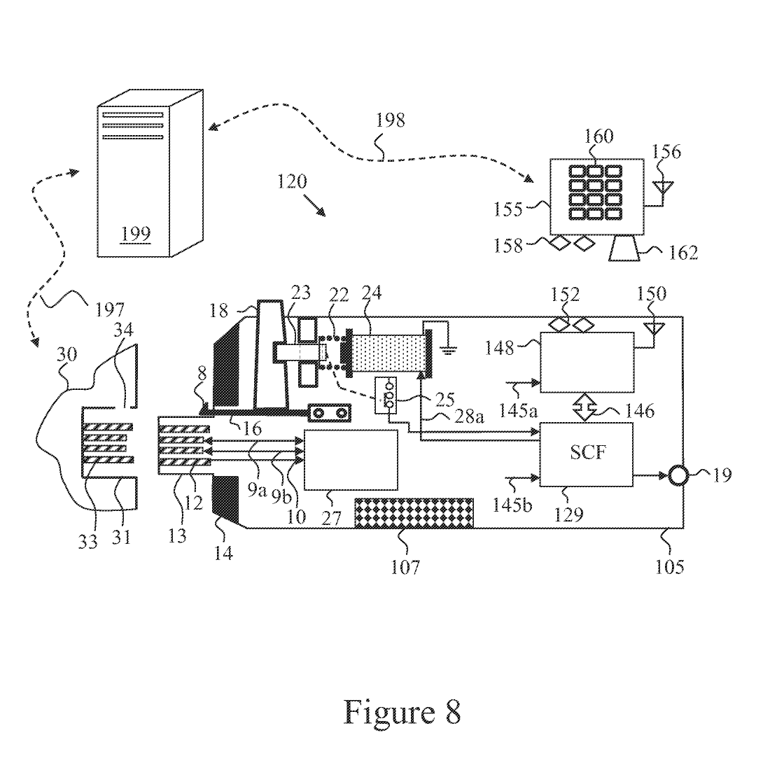

While this exemplary embodiment of the current invention provides good management and security levels, in some cases a higher security level may be needed. In particular there is a potential security vulnerability of a malicious code running on the host device 30 that may target the USB security plug 20 in attempt to support an unauthorized removal of the plug. This issue may be addressed by other embodiment of the current invention as illustrated in FIG. 8-12 below.

FIG. 8 illustrates a high-level functional diagram of an isolated USB security plug 120 according to an exemplary embodiment of the current invention having a solenoid that is driven by a Security Controller Function (SCF) 129 which is logically isolated from the USB jack interface of host 30. Such isolation enhances the device security as the release of the isolated USB security plug 120 is completely independent from the protected host device 30.

In this embodiment of the current invention solenoid 24 is driven by SCF 129 that also drives the optional LED indicator 19. The SCF 129 is also coupled to the switch or sensor 25 to receive indications about the device state. The SCF 129 is powered from the USB interface 5V power through line 145b via line 10.

It should be noted that the USB security plug 120 state can be fully defined by the switch or sensor state 25 and the 5V USB power input 145b. As state information can only be sensed while USB security plug 120 is powered and therefore inserted into a USB port of host device 30. When USB security plug 120 is fully inserted and powered there are only 2 state options:

a. Push-button 18 is locked

b. Push-button 18 is unlocked.

The SCF 129 receives control commands from the Wired or wireless remote-control receiver function 148 via bi-directional lines or bus 146. Wired or wireless remote-control receiver function 148 receives commands from remote device 155 through antenna 150 or electrical contacts 152. Antenna 150 may be Radio Frequency antenna or an inductor receiving commands through electromagnetic inductance. Wired or wireless remote-control receiver function 148 receives power from the USB interface 5V power through lines 145a and 10. Alternatively Wired or wireless remote-control receiver function 148 may receive power from the antenna 150 if inductor is used to receive commands and power. If Wired or wireless remote-control receiver function 148 is wireless receiver then antenna 150 must be installed outside the device enclosure 105 metal parts or alternatively, enclosure 105 is made of plastic material that do not significantly attenuating command signal reception.

Alternatively remote-control receiver function 148 may receive power from the remote device 155 through electrical contacts 152.

Wired or wireless remote-control receiver function 148 may use any secure wired or wireless communication method suitable for short distance, for example:

Conventional wired protocol

Radio Frequency (RF) remote control link

RFID (Radio Frequency Identification) link

Single wire communication protocol link

Human body communication link

Optical communication link

Remote control device 155 uses the selected link as described above to provide short distance remote control of the isolated USB security plug device 120. This control is preferably achieved through an encrypted communication link using device 155 antenna 156 (for wireless link) or contacts 158 (for wired link). Remote control device 155 may further comprising of means to detect nearby USB plug device serial number through bar-code reader 162 or an integrated receiver function that uses same antenna 156.

Keypad or touch-screen 160 may be added at the Remote control device 155 to enable manual entry of USB security plug serial numbers or to enter other commands.

Tamper Evident Label 107 may be installed on the isolated USB security plug device 120 outer enclosure 105 to provide clear indication if the device was mechanically tampered. Such label is preferably holographic surface having a special adhesive layer. Once the label is peeled or removed—clear indications of such removal appears in or under that label.

While installation (insertion) of this device 120 is similar to device 20 shown in FIGS. 3 to 7 above, the removal of this device is different. The user uses an appropriate Remote Control device 155 to detect, scan or enter appropriate USB security code associated with the specific isolated USB security plug device 120 and then send an encrypted command to unlock that device.

Optional LED indicator 19 provides a visual indication that the specific isolated USB security plug device 120 received the command and it is ready for safe removal (that is, solenoid 24 is energized). After preprogrammed time interval solenoid 24 is de-energized if the USB security device 120 was not removed first.

Remote control device 155 may serve as a master key for all USB security plug devices in the department/site/organization or it may be programmed to control only specific devices as needed according to the organizational security scheme.

Optionally, Remote control device 155 is in communication 198 with an optional security server 199 that monitors, logs and verify each removal of an isolated USB security plug device 120. Server 199 may be local, may be part of Remote control device 155, or may be a remote server. Optionally, sending the unlocking code is possible only after verification by the security server. Optionally, the optional security server 199 is further in communication 197 with host 30 in order to verify that the specific isolated USB security plug device 120 is installed in one of its USB jacks 31. Optionally, sending the unlocking code is possible only after verification by the security server at host 30 that isolated USB security plug device 120 is installed in one of its USB jacks 31, and there is authorization for its removal.

Communication channels 198 and 197 may be wired or wireless channels and optionally are standard computer communication channels, for example the communication channels used in the organization (e.g. LAN, WAN, WiFi, etc.). Preferably, secure communication protocol is used.

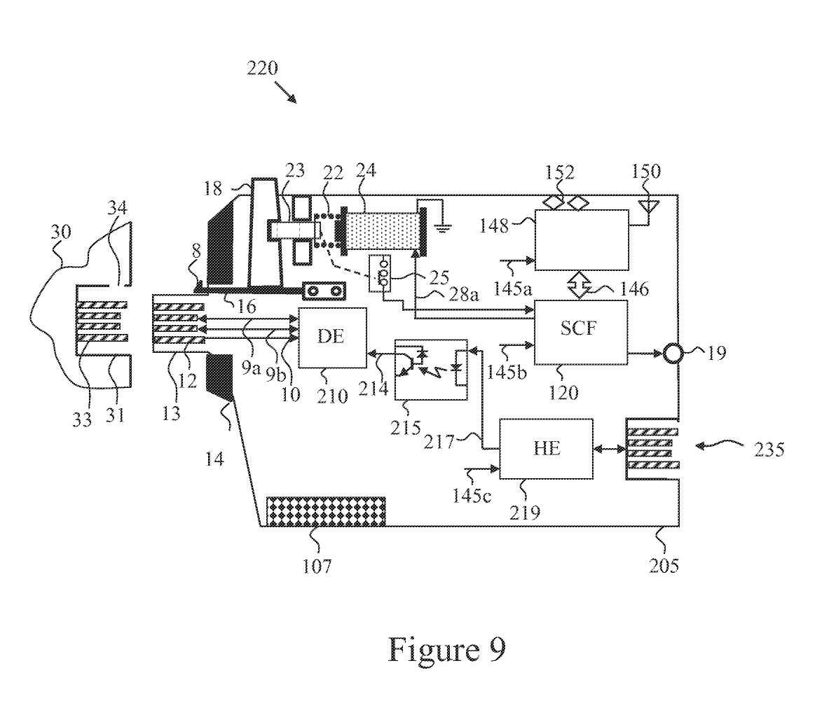

FIG. 9 illustrates a high-level block-diagram of yet another exemplary method and embodiment according to the present invention of a keyboard or mouse security device 220 having a unidirectional data diode function 215. In accordance with this exemplary embodiment of the current invention, the keyboard or mouse security device 220 comprises a device enclosure 205 having a USB jack 235 to enable connection of standard USB keyboard or mouse (not seen in these figures). In the following text it is assumed that a USB keyboard connected to USB jack 235 to simplify the description.

USB user keyboard or mouse jack 235 is coupled with host emulator function (HE) 219. Host emulator function 219 emulates a standard PC USB Human Interface Device host stack by receiving user keyboard entries. Host emulator function 219 is powered from the host device 5V USB power via host USB jack 31, line 10 and 145c. Same 5V power is also used to power the connected user keyboard and mouse through USB user keyboard and mouse jack 235.

Host emulator function 219 is preferably a microcontroller, ASIC (Application Specific Integrated Circuit), FPGA (Field Programmable Gate Array), System on a Chip or any other computing function that is capable of performing the required emulation. Host emulator function 219 converts the keyboard entries received from keyboard into a proprietary unidirectional data stream passed through line 217 to the unidirectional data enforcing device 215. Unidirectional data enforcing device is preferably and optical isolator, inductive isolator or any other electronic circuitry capable of assuring unidirectional data flow. From unidirectional data enforcing device 215 the proprietary unidirectional data stream is coupled through line 214 into the Device Emulator function (DE) 210. Device emulator function 210 emulates a standard PC keyboard device by receiving proprietary unidirectional data stream from line 214 and generating matching user keyboard entries over USB bus (lines 9a and 9b) coupled to the host device 30 via USB contacts 33. Device emulator function 210 is powered from the host device 5V USB power via line 10.

Device emulator function 210 is preferably a microcontroller, ASIC (Application Specific Integrated Circuit), FPGA (Field Programmable Gate Array), System on a Chip or any other computing function that is capable of performing the required emulation. Device emulator function 210 is preferably capable to provide authentication functions similar to the Authentication and security function 27 of FIGS. 3 to 5 above.

It should be noted that the operation of a USB mouse is similar to the operation of the USB keyboard that described above but instead of keyboard inputs, mouse inputs are passed to the host device. Optionally, the same keyboard or mouse security device 220 is capable of interfacing with and transmitting commands from a mouse or a keyboard.

Optionally, the keyboard or mouse security device 220 is capable of interfacing with, and transmitting commands from, both a mouse and a keyboard concurrently. This can be accomplished by having two USB jacks 235, or using an external USB hub or composite USB device, with both mouse and keyboard connected to it. In this exemplary embodiment of the current invention solenoid 24 is driven by SCF 129 that also drives the LED indicator 19. The SCF 129 is also coupled to the switch or sensor 25 to receive indications about the device state. The SCF 129 is powered from the USB interface 5V power through line 145b and 10.

The locking mechanism of this exemplary embodiment of the current invention is similar to the locking mechanism shown in FIG. 8 above. However, other locking or securing mechanisms may be used within the general scope of the current invention, for example, but not limited to locking or securing mechanisms as seen in other figures in this application, or as known in the art.

The SCF 129 receives control commands from the coupled to the Wired or wireless remote-control receiver function 148 via bi-directional lines or bus 146. Wired or wireless remote-control receiver function 148 receives commands from remote device 155 (seen in FIG. 8 and not shown in this figure) through antenna 150 or electrical contacts 152. Antenna 150 may be Radio Frequency antenna or an inductor receiving commands through electromagnetic inductance.

The use of this keyboard or mouse security device 220 described herein, having emulators and unidirectional data enforcing device provides the following security advantages over direct connection of USB keyboard or mouse to the host device:
a. It blocks USB devices other than keyboard and mouse;
b. It is capable of blocking unknown USB device connected behind USB hubs or composite USB devices;
c. It prevent abusing of the keyboard or mouse as mail-box to leak information between computers;
d. It prevents operation of an unauthorized device after the removal of the legitimate USB device (mouse or keyboard) and the connection of an unauthorized device instead; and
e. It prevents certain types of attacks that use tampered or modified USB devices.
f. Due to the unidirectional data enforcing device 215, no information may be obtained from host 30, regardless of the type of device connected to USB jack 235.

It should be noted that the topology of keyboard or mouse security device 220 having a unidirectional data diode function 215 may be used for preventing data leak when used with other USB input devices. For example, a user may need to upload imaged from a digital camera to host 30, yet the possibility of transferring images already stored on host 30 is to be prevented. This may be accomplished by adopting Host emulator 219 to communicate with a digital camera and accept data from it (most digital cameras are capable of “pushing” images to a host).

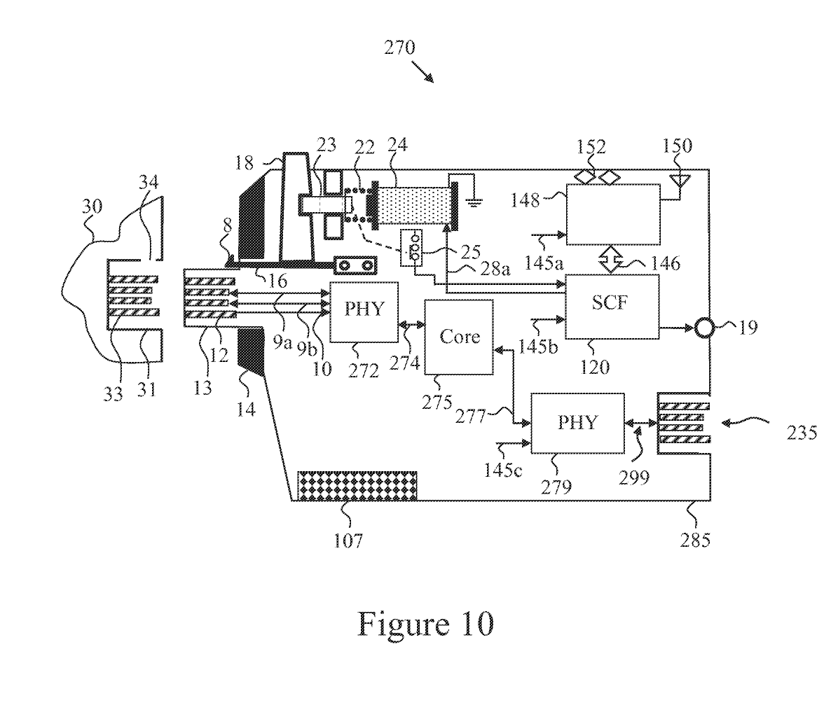

FIG. 10 illustrates a high-level block-diagram of yet another exemplary method and embodiment according to the present invention configured of a USB filter security device 270. USB filter security device 270 according to an exemplary embodiment of the current invention comprises a USB jack 235 in the device enclosure 285 that enables connection of specific USB devices to the host device 30 based on pre-defined policy stored in the a USB filter security device 270.

USB jack 235 is coupled to USB Physical layer function (PHY) 279. Physical layer function 279 interfaces between the USB bus 299 and the core function 275 internal bus 277.

Core function 275 is preferably a microcontroller, ASIC (Application Specific Integrated Circuit), FPGA (Field Programmable Gate Array), System on a Chip or any other computing function that is capable of performing the required filtering and security functions.

Core function 275 is programmed to perform the following tasks:
a. Enable enumeration of only predefined user devices based pre-programmed profile. Such profile may include one or more of the following USB characteristics: USB device class, USB device sub-class, protocol, manufacturer ID, Device name, and device serial number.
b. Pass or block specific USB packets based on predefined profile.
c. Prevent reading or writing traffic (enable only specific unidirectional traffic).
d. Emulating USB host and USB device for specific devices.

Core function 275 is further coupled through internal bus 274 to another USB physical layer function (PHY) 272 that is coupled through lines 9a and 9b, USB plug contacts 12 and host device contacts 33 into the host device USB port 31.

It should be noted that the core function 275 may be integrated with the two USB physical layer functions 279 and 272 into a single device having two USB interfaces (for example NXP or FreeScale ARM based microcontrollers having two USB ports).

The locking mechanism of this exemplary embodiment of the current invention is similar to the locking mechanism shown in FIGS. 8 and 9 above. However, other locking or securing mechanisms may be used within the general scope of the current invention, for example, but not limited to locking or securing mechanisms as seen in other figures in this application, or as known in the art.

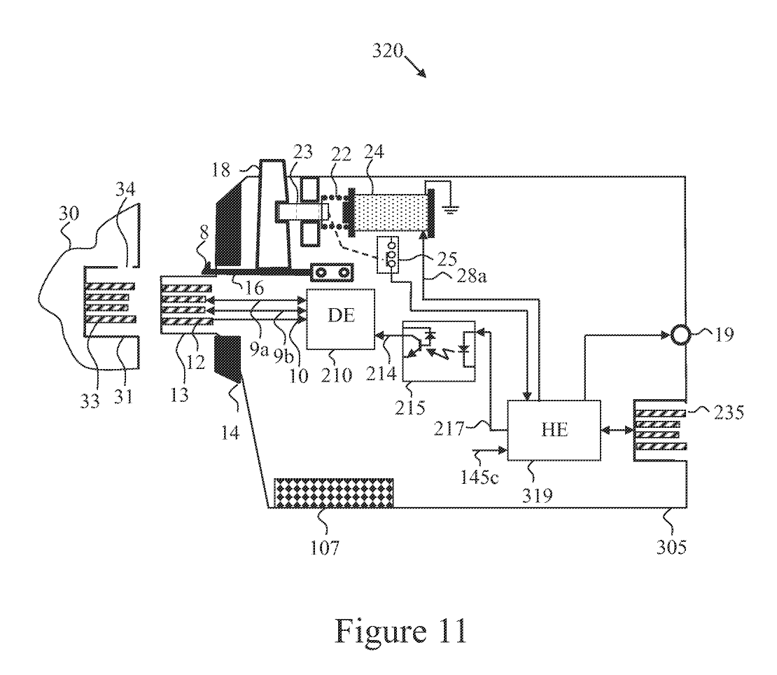

FIG. 11 illustrates a high-level block-diagram of yet another exemplary method and embodiment of the present invention configured as keyboard or mouse security device similar to the device in FIG. 9 above wherein in this embodiment the solenoid 24 is driven by the host emulator function 319. This implementation of the current invention enables the use of connected USB device to unlock the device. For example: a USB keyboard may be connected to the USB jack 235. When the user types a secret key, the host emulator function 319 authenticate that key. If key is correct then the host emulator function 319 energizes the solenoid 24 through solenoid activation line 28a to enable safe removal of the device 320.

The locking mechanism of this exemplary embodiment of the current invention is similar to the locking mechanism shown in FIGS. 8 and 9 above. However, other locking or securing mechanisms may be used within the general scope of the current invention, for example, but not limited to locking or securing mechanisms as seen in other figures in this application, or as known in the art.

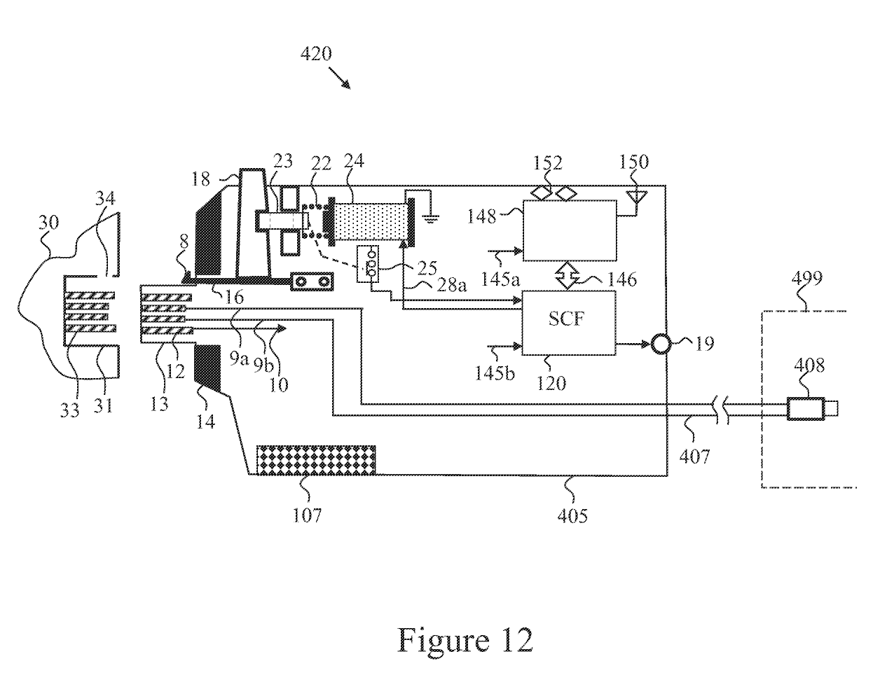

FIG. 12 illustrates a high-level block-diagram of yet another exemplary method and embodiment of the present invention configured as cable locking device 420. The purpose of such as cable locking device 430 is:
1. To secure the attached USB cable 407 device to the host device USB jack 31; and
2. To prevent unauthorized removal of the cable and connection of an unauthorized USB device to that port.

The exemplary cable locking device shown in FIG. 12 is having a fixed USB cable 407 and USB plug 408 attached to it through a hole and strain-relief part in the device enclosure 405. Cable 407 is coupled to the USB plug contacts 12 of the cable locking device 420 through lines 9a and 9b. USB plug 5V power line 10 is used to power internal device 420 circuitry.

The locking mechanism of this exemplary embodiment of the current invention is similar to the locking mechanism shown in FIGS. 8 to 10 above. However, other locking or securing mechanisms may be used within the general scope of the current invention, for example, but not limited to locking or securing mechanisms as seen in other figures in this application, or as known in the art.

The cable locking device 420 may be used to secure USB KVM (Keyboard Video Mouse) switch cable to a computer.

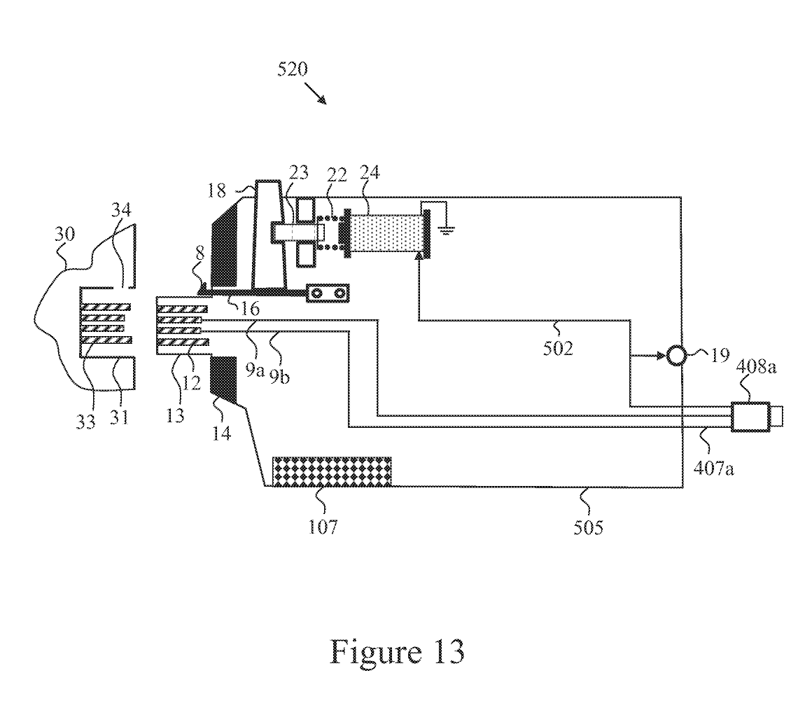

FIG. 13 illustrates a high-level block-diagram of yet another exemplary method and embodiment of the present invention configured as USB cable locking device 520 having a solenoid that is driven by the attached USB device.

The purpose of such device is to assure that only qualified equipment will be connected to that host computer by locking its USB cable to the host device USB port. This type of USB cable locking device may be used in conjunction with Secure KVM devices or secure peripheral devices. Another advantage of such device is that it secures the peripheral device to the host computer. Such function may be useful in the case of portable USB devices that may be abused to transfer data to other computers.

In this exemplary embodiment of the current invention, the USB cable locking device 520 is mechanically secured inside host device 30 USB jack 31 through similar solenoid based mechanism as shown in FIGS. 3 to 12 above. In this embodiment of the current invention the solenoid 24 is powered from the 5V supply line 502 coupled through USB cable 407a (exiting the device enclosure 505) and USB plug 408a to the attached USB device (not shown here). Attached USB device must switch the power supplied through cable 407a to enable unlock function control when needed. LED indicator 19 may be powered by same USB power line 502 or may be powered by host device 30 USB power if needed as line 502 is energized only when device 520 is being unlocked.

It should be noted that this embodiment of the current invention is less complex and less expensive than other options but it requires a non-standard USB port behavior from the attached USB device and therefore standard off-the shelve USB devices may not be used here.

Optionally, USB plug 408 or 408a (and the USB device that is connected to it, and is not seen in this figure) is placed in a secure enclosure 499 such that the user of host 30 cannot access the USB plug 408 and connect an unauthorized USB device to it.

Additionally or alternatively, other security measures are used to prevent disconnecting the authorized USB device from plug 408 and connecting an unauthorized USB device to it. For example, the authorized USB device connected to plug 408 may have an alarm function alerting that plug 408 was disconnected.

Alternatively, USB plug 408 or 408a may be missing, and the authorized USB device permanently attached to the cord 407 or 407a. For example, a keyboard or a mouse (or other authorized devices) having a cord ending with a USB cable locking device 420 or 520 may be securely connected to the host 30.

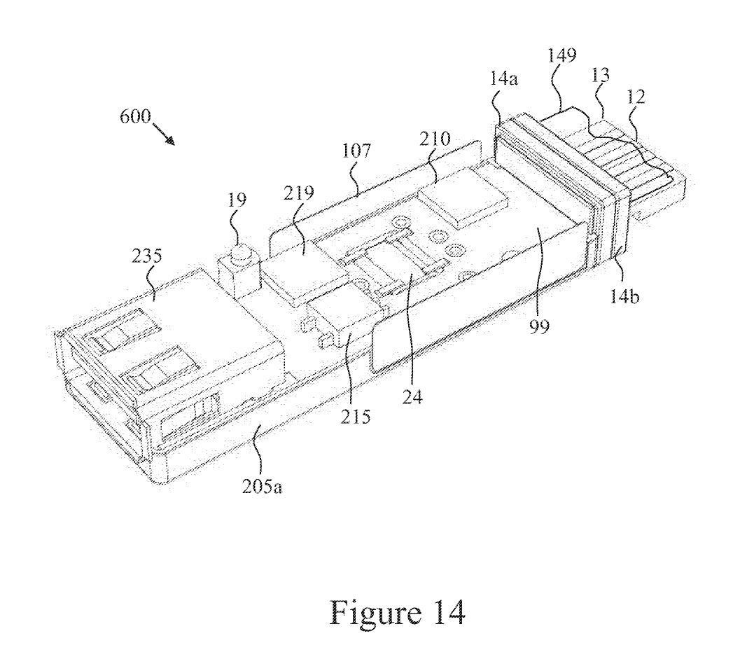

FIG. 14 illustrates a bottom side view mechanical diagram of an exemplary embodiment of the present invention configured as keyboard or mouse security device 600 similar to the device 220 in FIG. 9 above. In this view the bottom enclosure cover part 205b (seen in FIG. 15) was removed to expose the internal components.

In this embodiment of the current invention USB contacts 12 are printed on a Printed Circuit Board (PCB) 99 that forms the mechanical substrate for the whole device. Filler Removable rings 14a and 14b are plugged to one another to fill the gap between the device enclosure 205 (in this figure the upper half, 205a of the enclosure is seen) and the host device USB jack (not shown here).

Optionally, the rings are gap-fillers and modular and are designed to prevent easy removal while the device is locked. This may be done by:

Optionally the rings are designed in such way that they may be plugged to one another.

Optionally the last ring is constructed to be plug into the device enclosure.

The rings may be made of hard plastic or metal.

An example for oversized rings may be seen and are used by Kensington in their mechanical USB lock mentioned at the background section.

Device emulator function 210 is preferably a bare die, BGA (Ball Grid Array) or QFN (Quad-Flat No-leads) chip soldered, bonded or attached to the PCB 99 near the USB security plug 13. Solenoid 24 is soldered to the same board with four mechanical pins. Host emulator 219 is located near the device USB jack 235. Optical isolator 215 is located near the solenoid 24. LED indicator 19, soldered to the PCB 99, is designed to penetrate the device enclosure bottom part 205b (seen in FIG. 15) to provide clear visual indications of the device status.

FIG. 15 illustrates a top side view mechanical diagram of an exemplary embodiment of the present invention configured as keyboard or mouse security device 600 similar to the device 220 in FIG. 9 above. In this view the top enclosure cover 205a (seen in FIG. 14) was removed to expose the internal components.

USB security plug 13 is formed from PCB substrate 99. Top part of Push-button 18 is exposed from the removed enclosure top cover 205a. Push-button 18 is attached to flexible leaf spring 16 having two locking tooth 8a and 8b that are designed to lock inside standard USB jack 33 shielding tab holes 34. Metal lever 23 is mounted on metal hinge 26 with torsion spring 22 loading the metal lever under the leaf spring 16, thus preventing it from flexing downwards. When solenoid 24 is energized, it attracts the left side of the metal lever 23 and rotates counterclockwise the lever against the torsion spring 22 from under the leaf spring 16. This enables the push-button 18 and the leaf spring 16 to bend downwards and release the two locking tooth 8a and 8b from the host USB jack 31.

Tamper Evident Label 107 is attached between the two parts of the device enclosure 205a and 205b to provide clear visual indication if the enclosure parts were separated or tampered.

It should be noted that this or similar locking mechanism may be used with other embodiments of the invention, for example the embodiments seen in FIGS. 3-8, and 10-13 within the general scope of the current invention.

Optional metal shell 149 is placed, optionally on one side, or around security plugs 13 of plugs 20, 120, 220, 270, 320, 420, 520, or 600. Optionally, having an optional metal shell 149 around security plugs 13, plugs 20, 120, 220, 270, 320, 420, 520, or 600 conform with the form factor of standard USB plug except for the locking tooth 8a and 8b.

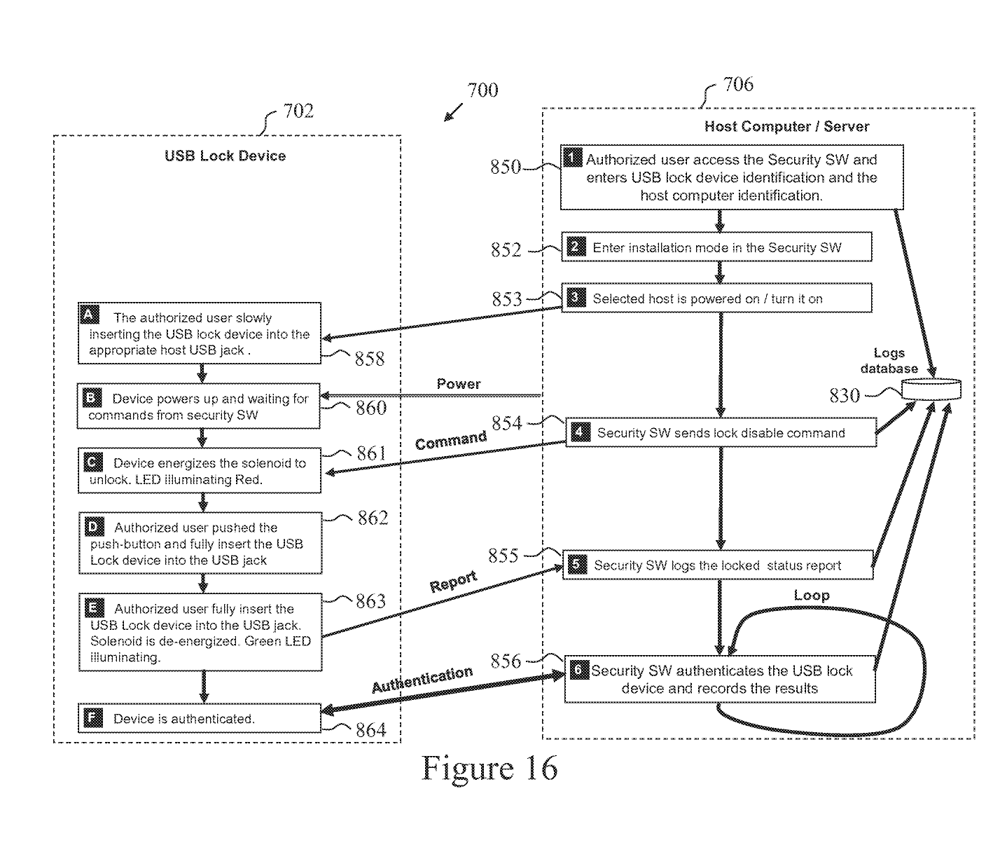

FIG. 16 illustrates a flowchart 700 of USB Lock device installation by an authorized user and continuous monitoring. In this figure:
1. The authorized user accesses the Security software executed at the host computer 30 or at another computer or server such as the optional security server 199, having network access to the host computer 706 and enters the applicable USB lock device 702 identification and the host computer 706 identification [See step 1 (850) in FIG. 16]. Information entered is logged in the log database 830.
2. The authorized user enters installation mode in the Security SW [See step 2 (852) in FIG. 16].
3. The authorized user verifies that the selected host 706 is powered on or turns on the selected host 706 [See step 3 (853) in FIG. 16].
4. The authorized user slowly inserting the USB lock device into the appropriate host (30) USB jack (31) [See step A (858) in FIG. 16].
5. Once USB lock device plug 13 contacts 12 are in contact with the host computer (30) USB jack (31) contacts (33), the USB security device 20, 120, 220, 270, 320, 420, 520, or 600 powers up and is waiting for commands from Security SW [See step B (860) in FIG. 16].
6. Security SW sends lock disable command to the target USB lock device [See step 4 (854) in FIG. 16].
7. Once lock disable command was received by the USB security device, solenoid 24 is energized and LED indicator 19 is illuminated in red color [See step C (861) in FIG. 16].
8. The authorized user can then push the push-button 18 and fully insert the device to the host USB jack 31 [See step D (862) in FIG. 16].
9. Once the solenoid 24 is de-energized, the USB lock device senses its state through switch or sensor 25 and report back to the Security SW that the device is now locked. LED indicator 19 is illuminating in green color to signal the user the secure state. Then, the USB Lock device reports that it is locked to the Security SW, and proper record is logged in the database 830 [See step E (863) in FIG. 16].
10. The installation event is logged in the security SW log database 830 with data entries such as: authorized user name, inserted USB lock device details, time and date [See step 5 (855) in FIG. 16].
11. The Security SW periodically re-authenticates each one of the USB Lock devices to maintain the system security. Each successful or unsuccessful authentication event is reported to the log database 830. [See steps 6 (856) and F (864) in FIG. 16]. Optionally, unsuccessful authentication event issues an alarm, and optionally attempts to disable at least some of the functionality of host 30 to minimize risk.

It should be noted that in some exemplary embodiments of the current invention, the USB lock device may be capable of being inserted and locked while it is unpowered. This can be achieved by designing the lock mechanism to be irreversible: that is, once it is inserted it is locked mechanically. In such case steps 3 to 10 above may not be necessary as host computer may be unpowered during USB lock device installation.

However, optionally, once host 702 is powered, the system is in a state arrived at step 863 (USB security device fully inserted and locked in place), and steps 9 to 10 may commenced.

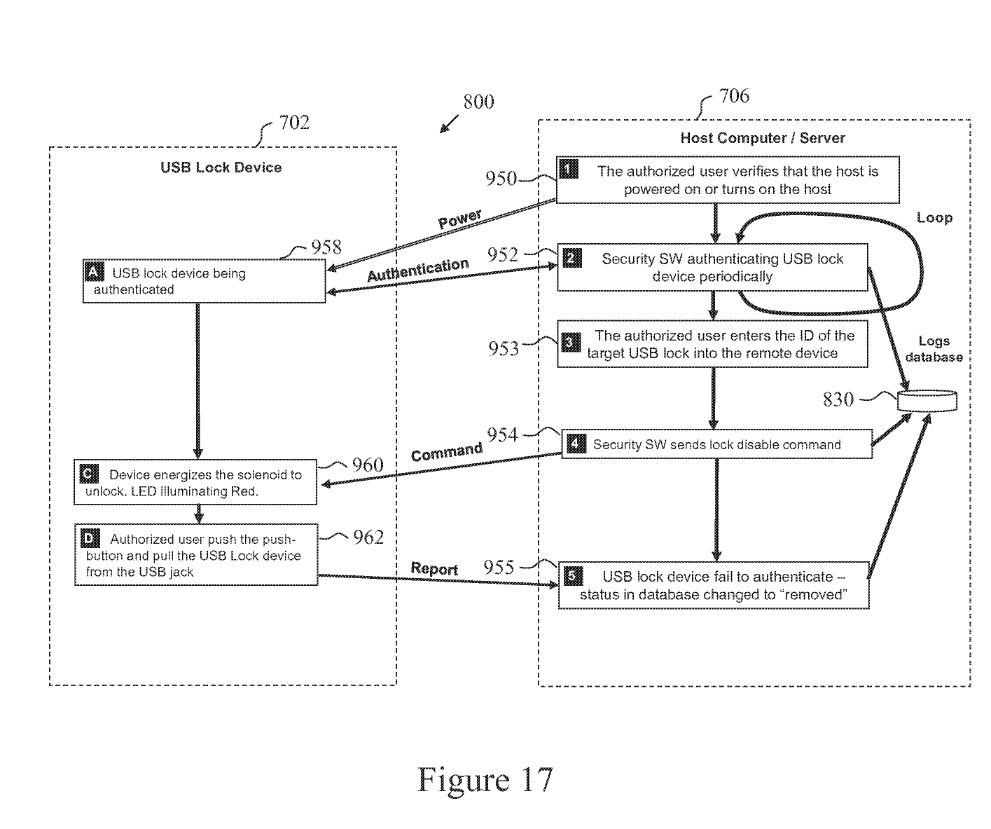

FIG. 17 illustrates a flowchart 800 of USB Lock device removal by an authorized user. In this figure:
1. The authorized user verifies that the host 706 is powered on, or turns on the host. [See step 1 (950) in FIG. 17].
2. Security SW in the host 706 is automatically executed on power-up and periodically communicating with the device 702 (USB security device 20, 120, 220, 270, 320, 420, 520, or 600) to provide continuous security through keep-alive and re-authentication [See step 2 (952) and step A (958) in FIG. 17]. Information is logged in log database 830. Optionally, unsuccessful authentication event issues an alarm, and optionally attempts to disable at least some of the functionality of host 30 to minimize risk.
3. The authorized user enters the ID of the target USB lock into the remote device 155 [See step 3 (953) in FIG. 17].
4. Security SW sends lock disable command to the target USB lock device [See step 4 (954) in FIG. 17].
5. The USB lock device energizing the solenoid 24 and provides proper user indication through Red LED 19 illumination [See step C (960) in FIG. 17].
6. The authorized user may now push the push-button 18 and pull the USB lock device from the host computer 30 [See step D (962) in FIG. 17].
7. Once the USB lock device is removed, it fails to communicate with the security SW and as result the security SW changing its state to “removed” to the log database 830. The removal event is logged in the security SW with data entries such as authorized user name, removed USB lock device details, time and date [See step 5 (955) in FIG. 17].
8. The authorized user then may enable the use of that port through the security SW to enable connection of all or some USB devices as defined by the authorized user permissions level and applicable network management group policies.

Referring back to FIG. 4, optionally, the user first inserts the USB security plug 20 part ways into USB connector 31 and waits for LED indicator 19 to turn on and indicate (for example by rapid blinking) that solenoid 24 is energized. The user than presses push-button 18, and advances USB security plug 20 all the way into USB connector 31 and then releases push-button 18 engaging locking tooth 8 with shielding tab holes 34. Optionally, after preset dwell time, solenoid 24 is de-energized, locking the USB security plug 20 in place. Optionally, authentication and security function 27 de-energizes solenoid 24 only after performing authentication and logging process against the host computer or server. Such process may prevent locking a USB port on a computer not having the corresponding security software, which may permanently lock the USB port (as there is no way to release the lock).

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects.

Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An Electronic USB Security Device comprising:
a USB plug, capable of interfacing the device with a USB jack of a host;
at least one locking tooth, shaped to lock inside shielding tab hole of said USB jack, thus locking the USB Security Device to said host; and
a solenoid, capable of enabling and disabling the locking of said at least one locking tooth to said shielding tab hole of said USB jack.

2. The Electronic USB Security device of claim 1 wherein said device is further comprising of an Authentication and security function, capable of enabling authentication of the USB Security device by a security software installed at said host.

3. The Electronic USB Security device of claim 1 wherein said solenoid is controlled by said Authentication and security function in response to commands received from said host.

4. The Electronic USB Security device of claim 1 wherein the USB Security device further comprising a visual indicator, capable of providing to a user visual indication of device lock and unlock states, wherein said visual indicator is selectable from the group consisting of: Light Emitting Diode (LED); Lamp, electromagnetic colored flag; and Liquid Crystal Display (LCD).

5. The Electronic USB Security device of claim 1 wherein the USB Security device further comprising a push-button, coupled to said at least one locking tooth, to enable safe removal of the USB Security device from said host by a user applying mechanical force pushing said push-button.

6. The Electronic USB Security device of claim 1 wherein the USB Security device further comprising a sensor, capable of providing electrical feedback about the state of said mechanical linkage.

7. The Electronic USB Security device of claim 1 wherein the USB Security device further comprising at least one removable ring, selectable from the group consisting of:
filler removable ring to enable user device adjustment to various host USB jack wall thicknesses; and
removable oversized ring to enable mechanical blocking of nearby connector.

8. The Electronic USB Security device of claim 1 wherein the USB Security device further comprising at least one Tamper Evident Labels (TEL) to enable authenticity validation and device physical tampering visual indications.

9. The Electronic USB Security device of claim 1 further comprising a Security Controller Function capable of driving said solenoid, wherein said Security Controller Function is coupled to a remote controller receiver function,
wherein said remote-control receiver function is capable of receiving user commands from a remote control device.

10. The Electronic USB Security device of claim 1 wherein the USB Security device further comprising at least one mechanically fixed cable, wherein said at least one cable is coupled to said USB Security device.

11. The Electronic USB Security device of claim 10 wherein said Solenoid is controlled through said mechanically fixed cable from a connected USB device.

12. The Electronic USB Security Device of claim 1 further comprising:
a USB jack, to connect a user USB device;
a USB Host interface Emulator function, coupled to the said USB jack;
a USB Device Emulator function coupled to the said USB plug; and
a unidirectional data flow enforcing device, coupled to said USB Host Emulator function unidirectional serial data output, and coupled to the said USB Device Emulator function unidirectional serial data input, forcing data flow only in the direction from said USB Host Emulator to said USB Device Emulator,
wherein the device is programmed to enumerate pre-defined user USB devices only.

13. The Electronic USB Security device of claim 12 wherein said solenoid is controlled by said Host Emulator function to enable device unlocking using a connected USB device.

14. The Electronic USB Security Device of claim 1 further comprising:
a USB jack, to connect user USB device;
a first USB Physical layer function coupled to the said USB jack;
a second USB Physical layer function, coupled to the said USB plug; and
a Core function,
said Core function is coupled to said first and second USB Physical layer functions, and
is capable of performing functions selectable from the list consisting of:
enabling enumeration of only predefined user devices based pre-programmed profile;
passing only specific USB packets based on predefined profile;
blocking specific USB packets based on predefined profile;
acting as a unidirectional device enabling data flow in only one specific direction; and
emulating USB host and USB device for specific devices.

15. A method using an electromechanical USB lock device by an authorized user comprising:
removing an electromechanical USB lock device from a USB port of a host computer by an authorized user by:
verifying that the host computer is powered,
wherein a security software in said host computer is automatically executed on power-up of said host and periodically communicating with the electromechanical USB lock device, and
wherein said electromechanical USB lock device is locked in the USB port of a host;
entering a code associated with said electromechanical USB lock device into a remote device;
communicating and authenticating a lock-release command from said remote device to said USB lock device;
in response to said lock-release command, unlocking said electromechanical USB lock device from said USB port; and
removing said electromechanical USB lock device from said USB port.

16. The method of using an electromechanical USB lock device of claim 15, further comprising:
logging the removal event in said security software.

17. The method using an electromechanical USB lock device claim 16, further comprising:
enabling the use of said USB port through said security software as defined by authorized user permissions level and applicable network management group policies.

18. The method of using an electromechanical USB lock device of claim 15, further comprising:
installing said electromechanical USB lock device by an authorized user, and continuous monitoring of the USB lock device by:
accessing a Security software and entering an applicable USB lock device identification and a host computer identification;
entering an installation mode in said Security software;
verifying that said host computer is powered;
inserting the USB lock device into the appropriate host USB jack; and
authenticating said the USB lock device and recording the results.

19. The method of using an electromechanical USB lock device of claim 18, further comprising logging said installing event in a remote server.

20. An electromechanically activated Security Device for a computer port comprising:
a plug capable of mating with a port of a host; and
an electromechanical lock, enclosed within said plug,
wherein said electromechanical lock is capable of locking said plug to said port, and
wherein said electromechanical lock is capable of being activated by a security software.
